(19) United States
(12) Patent Application Publication
(10) Pub. No.: US 2018/0056964 A1
(43) Pub. Date: Mar. 1, 2018

(54) BRAKE-BY-WIRE SYSTEM

(71) Applicant: GM Global Technology Operations LLC, Detroit, MI (US)

(72) Inventors: Brandon C. Pennala, Howell, MI (US); Christopher C. Chappell, Commerce Township, MI (US); Alan J. Houtman, Milford, MI (US); Paul A. Kilmurray, Wixom, MI (US); Eric E. Krueger, Chelsea, MI (US); Kevin S. Kidston, New Hudson, MI (US); Michael C. Roberts, Auburn Hills, MI (US); Steven J. Weber, Mount Clemens, MI (US); Patrick J. Monsere, Highland, MI (US)

(21) Appl. No.: 15/252,701

(22) Filed: Aug. 31, 2016

(51) Int. Cl. B60T 13/74; B60T 17/22

(52) U.S. Cl. CPC B60T 13/741; B60T 17/22; B60T 2270/402; B60T 2270/82; B60T 2270/415; B60T 2270/414; B60T 2270/404

(57) ABSTRACT

A vehicle includes a plurality of brake assemblies, and a brake request input device. Each brake assembly is coupled to a respective wheel of the vehicle and is configured to control braking of the respective wheel. The brake request input device is configured to output an electronic brake request signal indicating a request to brake at least one of the wheels. Each brake assembly has integrated therein an enhanced smart actuator unit that includes an electronic actuator controller configured to control a braking torque applied to the respective wheel in response to receiving the brake request signal.

### BACKGROUND

The invention disclosed herein relates to vehicle braking systems and, more particularly, to a vehicle including a brake-by-wire (BBW) system.

Current industrial automotive trends to reduce the number of overall mechanical components of the vehicle and to reduce the overall vehicle weight have contributed to the development of system-by-wire applications, typically referred to as X-by-wire systems. One such X-by-wire system that has recently received increased attention is a brake-by-wire (BBW) system, sometimes referred to as an electronic braking system (EBS). Unlike conventional mechanical braking systems, BBW systems actuate one or more vehicle braking components via an electric signal that is generated by an on-board processor/controller or is received from a source external to the vehicle.

BBW systems typically remove any direct mechanical linkages and/or hydraulic force-transmitting-paths between the vehicle operator and the brake control units. As such, much attention has been given to BBW control systems and control architectures that ensure reliable and robust operation. Various design techniques have been implemented to promote the reliability of the BBW system including, for example, redundancy, fault tolerance to undesired events (e.g., events affecting control signals, data, hardware, software or other elements of such systems), fault monitoring and recovery. Further improvements to enhance fault tolerant designs and/or system robustness is desirable.

### SUMMARY

According to a non-limiting embodiment, a vehicle is provided that includes a fault tolerant electronic brake-by-wire (BBW) system. The vehicle comprises a plurality of brake assemblies, and a brake request input device. Each brake assembly is coupled to a respective wheel of the vehicle and is configured to control braking of the respective wheel. The brake request input device is configured to output an electronic brake request signal indicating a request to brake at least one of the wheels. Each brake assembly has integrated therein an enhanced smart actuator unit that includes an electronic actuator controller configured to control a braking torque applied to the respective wheel in response to receiving the brake request signal.

According to another non-limiting embodiment, a method of controlling a fault tolerant electronic brake-by-wire (BBW) system of a vehicle comprises integrating in each brake assembly of the vehicle an electronic enhanced smart actuator unit. The method further comprises detecting a braking request indicating a request to brake at least one wheel of the vehicle. The method further comprises in response to detecting the braking request, independently applying a braking force to the at least one wheel in response to operating the enhanced smart actuator unit integrated in the brake assembly coupled to the at least one wheel.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a top schematic view of a vehicle having a BBW mechanism in accordance with an embodiment;

FIG. 2 illustrates an enhanced smart actuator unit including an actuator controller in electrical communication with an enhanced actuator unit;

FIG. 3 is a signal diagram illustrating various signal communications existing in a BBW system that includes a plurality of brake assemblies integrated with a respective enhanced smart actuator unit according to a non-limiting embodiment; and

FIG. 4 is a flow diagram illustrating a method of controlling a fault tolerant BBW system according to a non-limiting embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

Various non-limiting embodiments provide a BBW system including a plurality of enhanced smart brake actuator units each configured to control the braking force applied to an individual wheel. The enhanced smart brake actuator units each include an electro-mechanical actuator that applies the braking force, an actuator driver that drives the electro-mechanical actuator, and an electronic actuator controller. Each actuator controller is in electrical communication with one another. In this manner, the actuator controller integrated in any brake assembly is capable of controlling both its local actuator driver along with one or more actuator drivers included in remotely located brake assemblies. Accordingly, the level of unintentional electromagnetic compatibility (EMC) (e.g., generation, propagation and reception of electromagnetic energy) associated with the vehicle can be reduced. In addition, fault tolerance is provided since a brake assembly including a faulty actuator control module may still be controlled via a normal operating actuator controller included in a remotely located brake assembly.

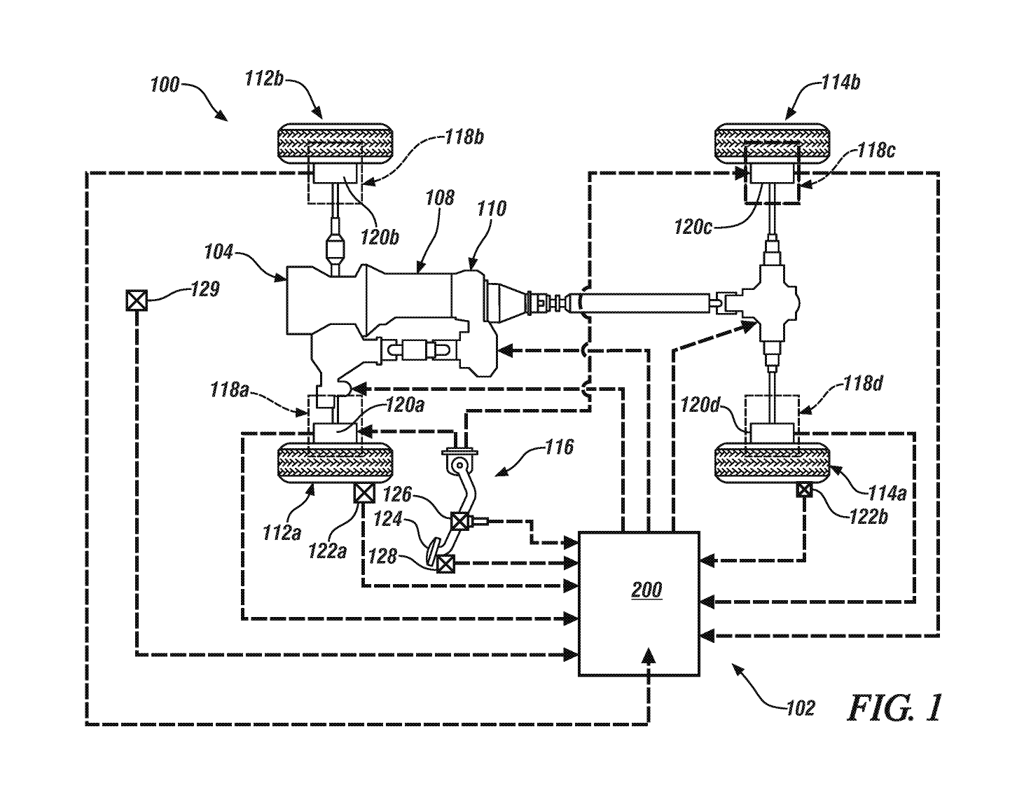

With reference now to FIG. 1, a vehicle 100, including BBW system 102 configured to electronically control braking of the vehicle 100 is illustrated according to a non-limiting embodiment. The vehicle 100 is driven according to a powertrain system that includes an engine 104, a transmission 108 and a transfer case 110. The engine 104 includes, for example, an engine 104 that is configured to generate drive torque that drives front wheels 112a and 112b and rear wheels 114a and 114b using various components of the vehicle driveline. Various types of engines 104 may be employed in the vehicle 100 including, but not limited to a spark-ignition engine, a combustion-ignition diesel engine, an electric motor, and a hybrid-type engine that combines an engine with an electric motor, for example. The vehicle may also include a battery electric vehicle including an electric motor. The vehicle driveline may be understood to comprise the various powertrain components, excluding the engine 104. According to a non-limiting embodiment, the engine drive torque is transferred to the transmission 108 via a rotatable crank shaft (not shown). Thus, the torque supplied to the transmission 108 may be adjusted in various manners including, for example, by controlling operation of the engine 104 as understood by one of ordinary skill in the art.

The BBW system 102 comprises a pedal assembly 116, brake assemblies 118a-118d (i.e., brake corner modules), one or more actuator units 120a-120d, one or more one or more wheel sensors 122a and 122b, and an EBS controller 200. In at least one embodiment, the actuator units 120a-120d are constructed as enhanced smart actuators which include an individual microcontroller and actuator driver (e.g., power circuits) as discussed in greater detail herein.

The pedal assembly 116 includes a brake pedal 124, a pedal force sensor 126, and a pedal travel sensor 128. The pedal assembly 116 can be any combination of hardware and software that virtualizes a conventional pedal assembly. For example, the pedal assembly 116 can be a pedal emulator that behaves like a conventional pedal of a hydraulic braking system while using various wires and electronics to omit one or more mechanical linkages and/or parts. In at least one embodiment, the pedal assembly 116 may be operated exclusively with electronic wiring and software thereby omitting various mechanical and/or hydraulic components found in traditional pedal assemblies.

Brake pedal travel and/or braking force applied to the brake pedal 124 may be determined based on respective signals output from the pedal force sensor 126, and a pedal travel sensor 128 as understood by one of ordinary skill in the art. According to a non-limiting embodiment, the pedal force sensor 126 is implemented as a pressure transducer or other suitable pressure sensor configured or adapted to precisely detect, measure, or otherwise determine an applied pressure or force imparted to the brake pedal 124 by an operator of vehicle 100. The pedal travel sensor 128 may be implemented as a pedal position and range sensor configured or adapted to precisely detect, measure, or otherwise determine the relative position and direction of travel of brake pedal 124 along a fixed range of motion when the brake pedal 124 is depressed or actuated.

The measurements or readings obtained by the pedal force sensor 126 and the pedal travel sensor 128 are transmittable or communicable as needed for use with one or more braking algorithms stored in the memory of an electronic controller. The data from the pedal force sensor 126 and/or pedal travel sensor 128 may also be used to calculate, select, and/or otherwise determine a corresponding braking request or braking event in response to the detected and recorded measurements or readings output from the wheel sensors 122a and 122b. Based on the determined braking request or braking event, the EBS controller 200 may perform various braking algorithms, speed calculations, distance-to-brake calculations, etc. In addition, the EBS controller 200 may control various braking mechanisms or systems such as, for example, an electronic emergency brake.

The wheel sensors 122a and 122b may provide various types of vehicle data including, but not limited to, speed, acceleration, deceleration, and vehicle angle with respect to the ground, and wheel slippage. Although only two wheel sensors 122a and 122b are shown, it should be appreciated that each wheel 112a and 112b/114a and 114b may include a respective wheel sensor. In at least one embodiment, the vehicle BBW system 102 may include one or more object detection sensors 129 disposed at various locations of the vehicle 100. The object detection sensors 129 are configured to detect the motion and/or existence of various objects surrounding the vehicle including, but not limited to, surrounding vehicles, pedestrians, street signs, and road hazards. The object detection sensors 129 may provide data indicating a scenario (e.g., a request and/or need) to slow down and/or stop the vehicle. The data may be provided by the pedal assembly 116, the wheel sensors 122a and 122b, and/or the object detection sensor 129. In response to determining the braking scenario, one or more brake assemblies 118a-118d may be controlled to slow or stop the vehicle 100 as discussed in greater detail herein.

According to at least one embodiment, the BBW system 102 may also include an isolator module (not shown in FIG. 1) and one or more power sources (not shown in FIG. 1). The isolator module may be configured as an electrical circuit and is configured to isolate fault circuits such as, for example, wire-to-wire short circuits on a signaling line circuit (SLC) loop. The isolator module also limits the number of modules or detectors that may be rendered inoperative by a circuit fault (e.g. short to ground or voltage, etc.) on the SLC Loop. According to a non-limiting embodiment, if a circuit fault condition occurs, the isolator module may automatically create and open-circuit (disconnect) the SLC loop so as to isolate the brake assemblies 118a-118d from a circuit fault condition. In addition, if a failure of a power source occurs, the isolator module may disconnect the failed power source while maintaining the remaining power sources. In this manner, the BBW system 102, according to a non-limiting embodiment, provides at least one fault tolerant feature, which may allow one or more brake assemblies 118a-118d to avoid failure in the event a circuit fault condition occurs in the EBS 200. When the circuit fault condition is removed, the isolator module may automatically reconnect the isolated section of the SLC loop, e.g., the brake assemblies 118a-118d.

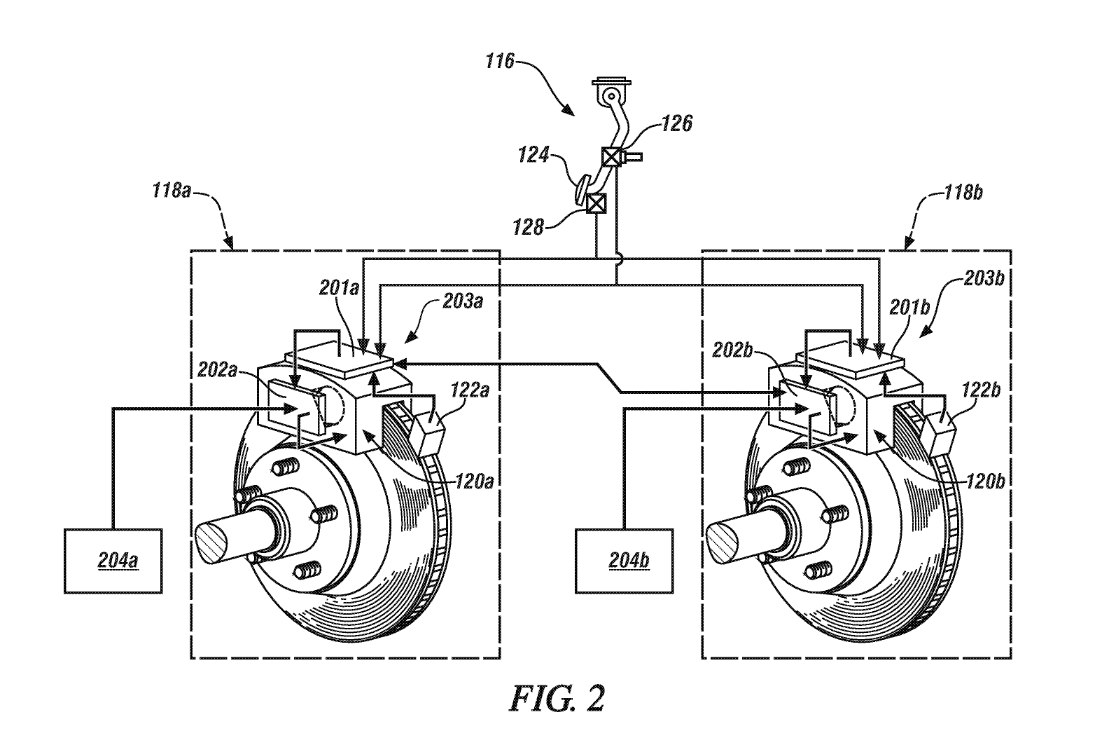

Referring to FIG. 2, a first enhanced smart actuator unit 203a is shown in signal communication with a second enhanced smart actuator unit 203b according to a non-limiting embodiment. Although a pair of enhanced smart actuator units (e.g., 203a and 203b) integrated in respective brake assemblies 118a and 118b are shown, it should be appreciated that the remaining enhanced smart actuators units integrated in the remaining brake assemblies 118c and 118d of the BBW system 102 may operate in a similar manner as described herein.

The enhanced smart actuator units 203a and 203b each include an actuator controller 201a and 201b, an actuator driver unit 202a and 202b such as one or more electronic power circuits 202a and 202b, and an electrically controlled actuator 120a and 120b such as, for example, an electronic brake caliper (e-caliper) and/or motor 120a and 120b. Combining the actuator controller 201a/201b, actuator driver unit 202a and 202b (e.g., power circuits), and electro-mechanical actuator 120a and 120b as a single component offers fast, robust, and diagnosable communication within a respective brake assembly 118a and 118b, while reducing data latency.

The actuator controller 201a and 201b selectively outputs a low-power data braking command signal (e.g., low-power digital signal) in response to one or more braking events such as a driver request to brake the vehicle 100. The data command signal may be delivered over a communication interface. The communication interface includes, but is not limited to, FlexRay™, Ethernet, and a low-power message based interface or transmission channel such as, for example, a controller area network (CAN) bus. FlexRay™ is a high-speed, fault tolerant time-triggered protocol including both static and dynamic frames. FlexRay™ may support high data rates of up to 10 Mbit/s.

The data command signal initiates the actuator driver unit 202a and 202b that drives a respective actuator (e.g., motor and/or e-caliper). In this manner, the enhanced smart actuator units 203a and 203b reduce the overall number of components and interconnection complexity of the BBW system 102 compared to conventional BBW systems. In addition, employment of one or more enhanced smart actuator units 203a and 203b assists in eliminating long-distance high-current switching wires, thereby reducing or even eliminating EMI emissions typically found in conventional BBW systems.

Each actuator controller (e.g., 201a and 201b) includes programmable memory (not shown in FIG. 1) and a microprocessor (not shown). The programmable memory may store flashable software to provide flexibility for production implementation. In this manner, the actuator controllers 201a and 201b are capable of rapidly executing the necessary control logic for implementing and controlling the actuator drivers 202a and 202b (e.g., power circuits 202a and 202b) using a brake pedal transition logic method or algorithm which is programmed or stored in memory. In at least one embodiment, the actuator controllers 201a and 201b may generate operational data associated with the vehicle. The operation data includes, but is not limited to, data indicating a torque force applied to a respective vehicle wheel, wheel speed of the wheel coupled to the respective brake assembly, brake torque wheel speed, motor current, brake pressure, and brake assembly temperature.

The actuator controllers 201a and 201b (e.g., the memory) may also be preloaded or preprogrammed with one or more braking torque look-up tables (LUTs) i.e. braking torque data tables readily accessible by the microprocessor in implementing or executing a braking algorithm. In at least one embodiment, the braking torque LUT stores recorded measurements or readings of the pedal assembly 116 (e.g., the pedal force sensor) and contains an associated commanded braking request appropriate for each of the detected force measurements. In a similar manner, the actuator controllers 201a and 201b may store a pedal position LUT, which corresponds to the measurements or readings monitored by the sensors (e.g., the pedal force sensor 126 and/or the pedal travel sensor 128) and contains a commanded braking request appropriate for the detected speed and/or position of the pedal 124.

In at least one embodiment, the enhanced smart actuator units 203a and 203b (e.g., the actuator controllers 201a and 201b) may communicate with one another via a low-power message based interface such as, for example, a controller area network (CAN) bus. In this manner, any of the enhanced smart actuator units 203a-203d (e.g., the individual actuator controllers) may share data with one or more other enhanced smart actuator units 203a-203d included in BBW system 102. The shared data includes, for example, detected brake requests and diagnostic results obtained after performing self-diagnostic tests.

The individual actuator driver units 202a and 202b (e.g., the power circuits) receive a constant high power input signal (e.g., non-switched high power input current) from one or more power sources 204a and 204b. The high power input signal may include a high power current signal ranging from approximately 0 amps to approximately 200 amps

The actuator driver units 202a and 202b may include various high-power electronic components including, but not limited to, h-bridges, heat sinks, application-specific integrated circuits (ASICs), controller area network (CAN) transceivers or temperature or current sensors. In response to receiving a braking event data command signal from a respective actuator controller 201a-201d, each actuator driver unit (e.g. 202a and 202b) is configured to output a high-frequency switched high-power signal to a respective electro-mechanical actuator integrated 120a and 120b. For example, the first actuator controller 201a may output a first braking event data command signal to a first power circuit 202a integrated locally in the first enhanced smart actuator unit 203a and the second actuator controller 201b may output a second braking event data command signal to the second power circuit 202b integrated locally in the second enhanced smart actuator unit 203b. In response to receiving the data command signals, the first actuator driver unit 202a and the second actuator driver unit 202b may operate to convert the continuous high power current signal output from the first and second power sources 204a and 204b into a high-frequency switched high-current signal which then drives the actuator 120a and 120b (e.g., motor and/or e-caliper) integrated in their respective brake assembly 118a and 118b.

In at least one embodiment, the high-frequency switched high-current signal is generated by a pulse width modulation (PWM) circuit included in an actuator driver unit 202a-202d of a respective enhanced smart actuator 203a-203d. The high-frequency switched high-current signal may have a frequency ranging from approximately 15 kilohertz (kHz) to approximately 65 kHz, and may have a current value of approximately 0 amps to approximately 200 amps. In turn, the high-frequency switched high-current signal drives a respective electro-mechanical actuator 120a-120d, e.g., a motor, which adjusts the e-caliper so as to apply the necessary braking force to the wheel coupled to the respective brake assembly 118a-118d to slow down and/or stop the vehicle 100.

Since each enhanced smart actuator unit 203a/203d includes an individual actuator driver unit 202a and 202b, the power circuits associated with the actuator driver units 202a and 202b may be located in close proximity of a respective actuator 120a and 120b (e.g., motor and/or e-caliper). In this manner, the length of the high-current wires that deliver the switching high-frequency current signals (illustrated as dashed arrows) for driving a respective actuator 120a and 120b may be reduced. In at least one embodiment, the actuator driver units 202a and 202b abut a respective actuator 120a and 120b so as to completely eliminate conventional high-current wires typically required to deliver switched high-frequency high-current signals.

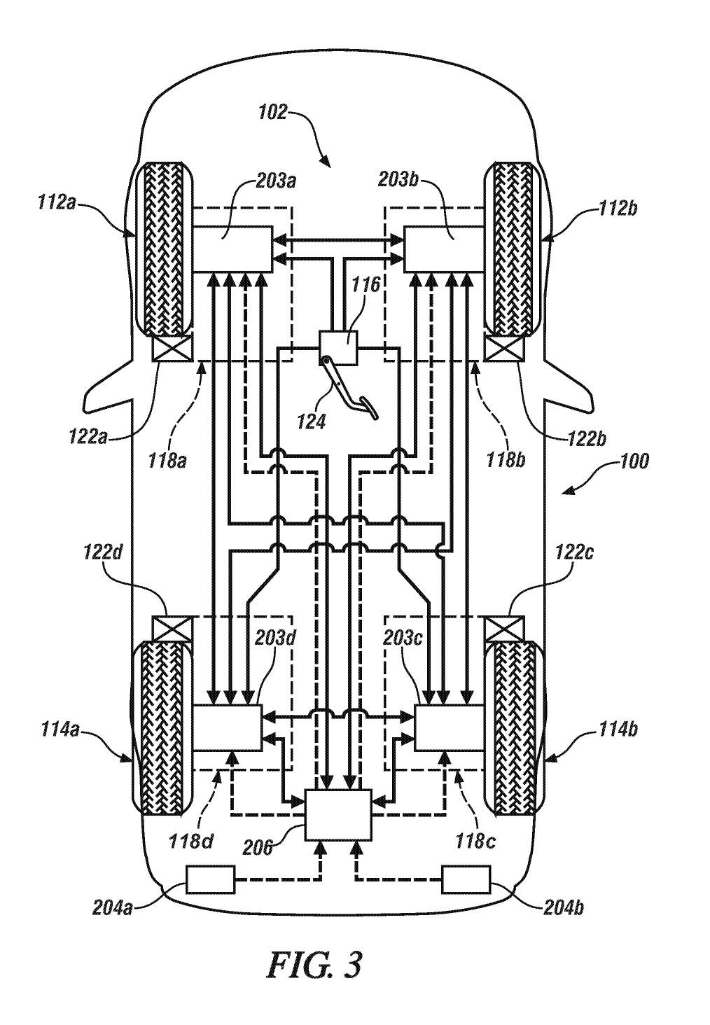

Turning to FIG. 3, a signal diagram illustrates the various signal connections existing in a BBW system 102 that includes a plurality of brake assemblies 118a-118d integrated with a respective enhanced smart actuator unit 203a-203d according to a non-limiting embodiment. Each enhanced smart actuator unit 203a-203d may control braking of a respective wheel 112a and 112b/114a and 114b. For example, a first enhanced smart actuator unit 203a may control braking of a first wheel 112a located at a front driver-side of the vehicle 100, a second enhanced smart actuator unit 203b may control braking of a second wheel 112b located at a front passenger-side of the vehicle, a third enhanced smart actuator unit 203c may control braking of a third wheel 114b located at the rear passenger-side of the vehicle 100, and a fourth enhanced smart enhanced actuator unit 203d may control braking of a fourth wheel 114a located at the rear driver-side of the vehicle 100.

As discussed above, each brake assembly 118a-118d includes an enhanced smart actuator unit 203a-203d, which integrates therein its own individual actuator controller, an electronically controlled actuator, and an actuator driver unit, e.g., electronic power circuits (see FIG. 2). The electro-mechanical actuators (e.g., motor and/or e-caliper) operate in response to a high-frequency switched high-power current output by a respective actuator driver unit (e.g., power circuit) so as to apply a variable (i.e., adjustable) frictional force to slow down a respective wheel 112a and 112b/114a and 114b in response to a braking command input by the vehicle driver.

As can be appreciated from FIG. 3, since each enhanced smart actuator unit 203-203d includes an individual actuator driver unit, the power circuits necessary to generate the high-frequency switched high-power signals may be located in close proximity to a respective actuator (e.g., motor and/or e-caliper). In this manner, the length of the high-current wires that deliver the switching high-frequency current signals for driving a respective actuator is greatly reduced.

Each enhanced smart actuator unit 203a-203d receives a constant high-power signal generated by a first power source 204a and/or a second power source 204b. In at least one embodiment, an isolator module 206 isolates the first and second power sources 204a and 204b from the remaining electrical system of the BBW system 102. The isolator module 206 is configured to receive the constant high-power signals generated by the first and second power sources 204a and 204b and generates various outputs signals that power the various components integrated in the enhanced smart actuator units 203a-203d.

For example, the isolator module 206 outputs first and second constant high voltage power signals to each actuator driver unit integrated in a respective enhanced smart actuator unit as described in detail above. The isolator module 206 also outputs first and second low power signals that power the individual actuator controllers included in a respective enhanced smart actuator unit 203a-203d. In at least one embodiment, the enhanced smart actuators 203a-203d may communicate with the isolator module 206 to obtain various diagnostic information and circuit fault information including, but not limited to, short circuit events, open circuit events, and over voltage events.

As mentioned above, the isolator module 206 may also be configured to isolate circuit faults such as, for example, wire-to-wire short circuits on a signaling line circuit (SLC) loop, and is capable of limiting the number of modules or detectors that may be rendered inoperative by a circuit fault on the SLC loop. The circuit fault may include, but is not limited to, a short-circuit, short-to-ground, and over-voltage. According to a non-limiting embodiment, if a wire-to-wire short occurs, the isolator module 206 may automatically disconnect the SLC loop so as to isolate the enhanced smart actuators 203a-203d from a circuit fault condition. In this manner, the BBW system 102 according to a non-limiting embodiment provides at least one fault tolerant feature. When the circuit fault condition is removed, the isolator module 206 may automatically reconnect the isolated section of the SLC loop, e.g., reconnect the brake assemblies 118a-118d.

In at least one embodiment, the enhanced smart actuator units 203a-203d may communicate with one another via a low-power message based interface such as, for example, a controller area network (CAN) bus. In this manner, any of the enhanced smart actuator units 203a-203d (e.g., the individual actuator controllers) may share data with one or more other enhanced smart actuator units 203a-203d included in BBW system 102. The shared data includes, for example, detected brake requests, and diagnostic results obtained after performing self-diagnostic tests.

The enhanced smart actuator units 203a-203d are also capable of monitoring the state of the vehicle 100 based on inputs provided by one or more sensors. The sensors include, but are not limited to, the wheel sensors 122a and 122b, data signals output from the pedal assembly 116, and object detection sensors 129. Although not illustrated in FIG. 3, the pedal assembly 116 includes various sensors that monitor the pedal 124 including, but not limited to, a pedal force sensor and a pedal travel sensor (see FIGS. 1-2). The outputs of the pedal force sensor and the pedal travel sensor may be delivered to each enhanced smart actuator unit 203a-203d to provide output redundancy and back-up control. Based on the state of the vehicle 100, one or more of the enhanced smart actuator units 203a-203d may determine whether to invoke a braking event to slow down and/or stop the wheel 112a and 112b/114a and 114b coupled to a respective brake assembly 118a-118d.

According to at least one non-limiting embodiment, the smart actuator units 203a-203d may compare their individually detected braking event data via a low-power message-based interface (e.g., CAN bus). In this manner, the enhanced smart actuator units 203a-203d can determine whether they all received the same or substantially the same braking event data (e.g., a driver request to brake the vehicle) and can therefore diagnose the operation of one another. When the braking event data monitored and generated by the enhanced smart actuator units 203a-203d matches or substantially matches, each enhanced smart actuator unit 203a-203d adjusts the braking torque applied to wheel 112a and 112b, and 114a and 114b coupled to their respective brake assembly 118a-118d. Accordingly, each wheel 112a and 112b and 114a and 114b is independently controlled by its respective brake assembly 118a-118d.

When, however, the braking event data among all the enhanced smart actuator units 203a-203d does not match, one or more of the enhanced smart actuator units may be determined as faulty. For example, an actuator controller included with a particular enhanced smart actuator unit (e.g., 203a) may experience a fault and therefore does not receive the braking event data detected by the remaining enhanced smart actuator units (e.g., 203b-203d). Accordingly, the remaining enhanced smart actuator units 203b-203d determine that enhanced smart actuator unit 203a is experiencing a fault, and can take action to disable the faulty enhanced smart actuator unit (e.g., 203a). In one embodiment, one or more of the normal operating enhanced actuator units (e.g., 203b-203d) may output a command signal to the faulty enhanced actuator unit (e.g., 203a), which commands the faulty enhanced actuator unit 203a to power down.

The normal operating enhanced actuator units (e.g., 203b-203d) may also output a shutdown command signal to the isolator module 206, and command the isolator module 206 to cut power to the faulty enhanced smart actuator unit 203a. In response to the shutdown command, the isolator module 206 disconnects the low-power signal necessary for powering the actuator controller included in the faulty enhanced smart actuator unit 2023a thereby effectively disabling the actuator controller.

Despite disabling the actuator controller, the actuator driver unit of a faulty enhanced smart actuator unit (e.g. 203a) may still be initiated to drive the electro-mechanical actuator of its respective brake assembly (e.g., 118a) since the faulty enhanced smart actuator unit 203a is in signal communication with the remaining normal operating enhanced smart actuator units 203b-203d. For instance, the powered actuator controller of any one of the remaining normal operating enhanced smart actuator units 203b-203d may output a command signal to the faulty enhanced smart actuator unit 203a so as to initiate its respective actuator driver unit. Therefore, at least one of the remaining normal enhanced smart actuators (e.g., 203b-203d) is capable of initiating its own local actuator driver unit along with a remotely located actuator driver unit included in a faulty enhanced smart actuator unit (e.g., 203a). Accordingly, each brake assembly 118a-118d may still control braking of its respective vehicle wheel 112a and 112b and 114a and 114b despite the existence of a faulty enhanced smart actuator unit (e.g., a faulty actuator controller).

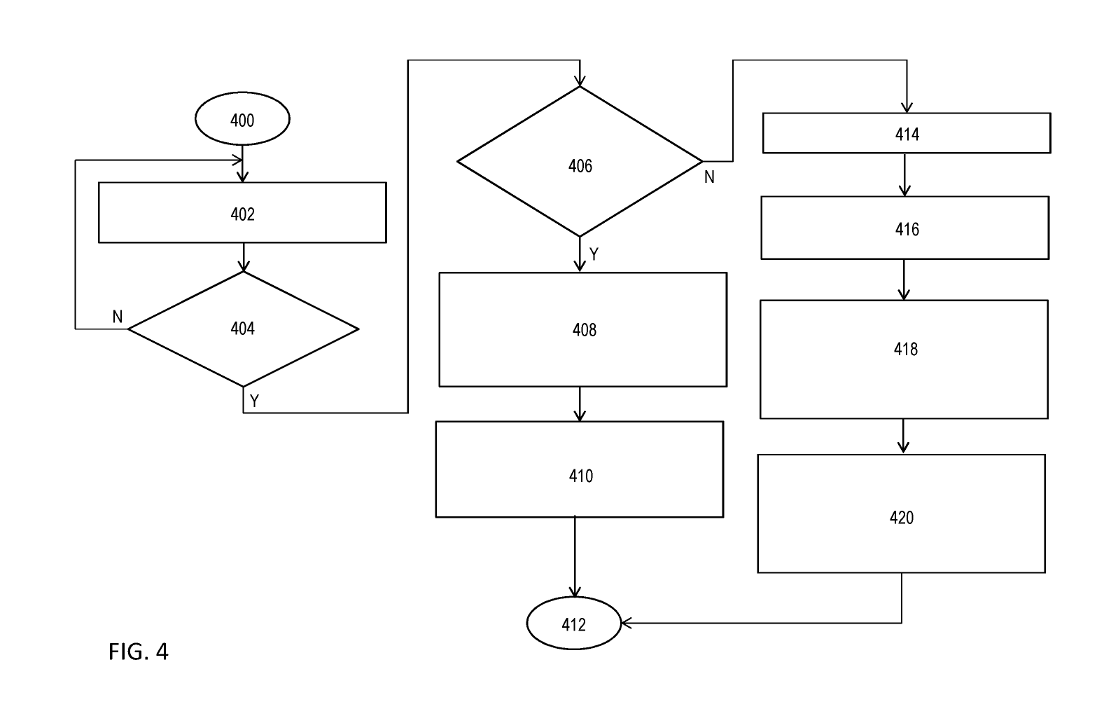

Turning now to FIG. 4, a flow diagram illustrates a method of controlling a fault tolerant electronic brake system according to a non-limiting embodiment. The method begins at operation 400 and at operation 402, sensor data is output to a plurality of enhanced smart actuator units. Each enhanced smart actuator unit is integrated in an individual brake assembly which is configured to apply a braking force to a respective wheel of the vehicle. The sensor data may be output from various sensors installed on the vehicle including, but not limited to, wheel sensors, brake pedal sensors, and/or object detection sensors. At operation 404, a determination is made as to whether at least one enhanced smart actuator unit detects a braking event. The braking event is based on the sensor data described above. When no braking event is detected, the method returns to operation 402 and continues monitoring the sensor data.

When at least one of the enhanced smart actuator units detects a braking event, however, the method proceeds to operation 406 and each smart actuator unit communicates with one another so as to compare their respective detected braking event data. In this manner, the enhanced smart actuator units can determine whether they all received the same or substantially the same braking event data (e.g., a driver request to brake the vehicle). When the braking event data monitored and generated by the enhanced smart actuator units matches or substantially matches, the method proceeds to operation 408 where each actuator controller of a respective enhanced smart actuator unit outputs a digital command signal to initiate their local actuator driver unit (e.g., high power circuits). At operation 410, each electrical power circuit drives their local electro-mechanical actuator, which in turn adjusts the braking torque applied to the wheel coupled to the respective brake assembly. In this manner, each wheel of the vehicle can be slowed or stopped based on the operation of the enhanced smart actuator unit integrated in the respective brake assembly, and the method ends at 412.

Referring back to operation 406, a scenario may occur where the braking event data monitored and generated by the first enhanced smart actuator does not match or substantially match the braking event data monitored and generated by the second enhanced smart actuator. For example, an actuator controller of a particular brake assembly may experience a fault and therefore does not receive the braking event data. When the braking event data does not match among all enhanced smart actuator units, the method proceeds to operation 414 and one or more faulty enhanced smart actuator units are identified.

At operation 416, the actuator controller of each faulty enhanced smart actuator unit is disabled (e.g., disconnected from power). At operation 418, at least one remaining normal operating enhanced smart actuator unit (e.g., a remaining powered actuator controller) outputs a data command signal to the power circuits of the faulty enhanced smart actuator unit. Accordingly, at least one normally operating enhanced smart actuator unit initiates its own local power circuit along with one or more remotely located power circuits included in a faulty enhanced smart actuator unit. Accordingly, at operation 420, the power circuit of a faulty enhanced smart actuator unit drives its respective electro-mechanical actuator based on the output signal from a remotely located active enhanced smart actuator unit (e.g., a remaining powered actuator controller) and the method ends at operation 412. In this manner, a fault tolerance is introduced into the BBW system such that the power circuits integrated in each braking assembly may still drive their respective electro-mechanical actuator (e.g., motor/e-caliper) despite the existence of a fault (e.g., a faulty actuator controller) in one or more of the enhanced smart actuator units.

As described in detail above, various non-limiting embodiments provide a BBW system including a data interface connecting electronic brake controllers and enhanced smart brake actuators. According to a non-limiting embodiment, a first enhanced smart actuator included in a first brake assembly is controlled by a first actuator controller while a second enhanced smart actuator included in a second brake assembly is controlled by a second actuator controller. Each actuator controller may output low-power data command signals to a respective actuator driver (e.g., power circuit) via a communication interface. The communication interface includes, but is not limited to, FlexRay™, Ethernet, and a low-power message-based interface such as, for example, a controller area network (CAN) bus. Accordingly, a flexible BBW system is provided that allows for flexible design choice, wire length reduction, and flexible braking algorithm implementation, while still employing fault tolerance into the system.

As used herein, the term “module” or “unit” refers to an application specific integrated circuit (ASIC), a field programmable gate array (FPGA), an electronic circuit, an electronic computer processor (shared, dedicated, or group) and memory that executes one or more software or firmware programs, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

While the embodiments have been described, it will be understood by those skilled in the art that various changes may be made and equivalents may be substituted for elements thereof without departing from the scope of the embodiments. In addition, many modifications may be made to adapt a particular situation or material to the teachings of the embodiments without departing from the essential scope thereof. Therefore, it is intended that the disclosure not be limited to the particular embodiments disclosed, but that the disclosure will include all embodiments falling within the scope of the application.

1. A vehicle including a fault tolerant electronic brake-by-wire (BBW) system, the vehicle comprising:
a plurality of brake assemblies, each brake assembly coupled to a respective wheel of the vehicle and configured to control braking of the respective wheel; and
a brake request input device configured to output an electronic brake request signal indicating a request to brake at least one of the wheels,
wherein each brake assembly has integrated therein an enhanced smart actuator unit that includes an electronic actuator controller configured to control a torque applied to the respective wheel in response to receiving the brake request signal, and
wherein each enhanced smart actuator unit is in electrical communication with one another such that a first actuator controller integrated in a first brake assembly is configured to control a first torque applied to a first wheel coupled to the first brake assembly, and a second torque applied to a second wheel coupled to a second brake assembly that excludes the first actuator controller.

2. (canceled)

3. The vehicle of 1, wherein the enhanced smart actuator unit included in each brake assembly further includes:
an electro-mechanical actuator that is configured to apply a variable braking force to the respective wheel; and
an electronic actuator driver configured to output a high-power signal that drives the electro-mechanical actuator in response to receiving a brake command signal output by at least one actuator controller.

4. The vehicle of claim 3, wherein the actuator driver includes a power circuit configured to output a high-frequency switched high-power current drive signal that drives the electro-mechanical actuator integrated in the respective brake assembly, the current drive signal having a current threshold of about 200 amperes and a frequency threshold of about 65 kilohertz (KHz).

5. The vehicle of claim 4, wherein each actuator controller generates operational data based on at least one of a torque force applied to the wheel coupled to a respective brake assembly and a speed of the wheel coupled to the respective brake assembly.

6. The vehicle of claim 3, wherein the enhanced smart actuator units diagnose operation of one another based on the operational data.

7. The vehicle of claim 6, wherein a second actuator controller integrated in the second brake assembly is identified as faulty when operational data determined by the second actuator controller does not match operational data determined by the actuator controller integrated in remaining brake assemblies.

8. The vehicle of claim 7, wherein the second actuator controller is disabled in response to being identified as faulty, and the first actuator controller outputs the brake command signal to initiate the electronic actuator driver integrated in both the first brake assembly and the second brake assembly.

9. A method of controlling a fault tolerant electronic brake-by-wire (BBW) system of a vehicle, the method comprising:
providing the vehicle with a plurality of brake assemblies;
integrating in each brake assembly of the vehicle an electronic enhanced smart actuator unit;
detecting a braking request indicating a request to brake at least one wheel of the vehicle; and
in response to detecting the braking request, independently applying a braking force to the at least one wheel in response to operating the enhanced smart actuator unit integrated in the brake assembly coupled to the at least one wheel,
wherein independently applying the braking force comprises:
controlling a first torque applied to a first wheel coupled to a first brake assembly of the plurality of brake assemblies based on a first electronic actuator controller integrated in the first brake assembly; and
controlling a second torque applied to a second wheel coupled to a second brake assembly of the plurality of brake assemblies based on a second electronic actuator controller integrated in a second brake assembly that excludes the first actuator controller.

10. (canceled)

11. The method of claim 9, wherein the enhanced smart actuator unit included in each respective brake assembly of the plurality of brake assemblies further comprises:
an electro-mechanical actuator that is configured to apply a variable braking force to the wheel coupled to the respective brake assembly; and
an electronic actuator driver configured to output a high-power drive signal that drives the electro-mechanical actuator in response to receiving a brake command signal.

12. The method of claim 11, further comprising generating operational data via each actuator controller based on at least one of a torque force applied to a respective wheel and speed of the respective wheel coupled to the respective brake assembly.

13. The method of claim 12, further comprising diagnosing operation of a first enhanced smart actuator unit integrated in the first brake assembly via a second enhanced smart actuator unit integrated in the second brake assembly based on the operational data.

14. The method of claim 13, further comprising determining a fault associated with the second actuator controller of the second enhanced smart actuator unit when operational data determined by the second actuator controller does not match operational data determined by the actuator controller integrated in at least one brake assembly that excludes the second actuator controller.

15. The method of claim 14, further comprising disabling the second actuator controller in response to determining the fault, and outputting the brake command signal from the at least one brake assembly that excludes the second actuator controller so as to initiate the electronic actuator driver integrated in both the second brake assembly and the at least one brake assembly that excludes the second actuator controller.
